(19) United States
(12) Patent Application Publication
(10) Pub. No.: US 2010/0299717 A1
(43) Pub. Date: Nov. 25, 2010

(54) System for Annotation-Based Access Control

(75) Inventors: Peyman NASIRIFARD, Galway (IE); Vassilios PERISTERAS, Galway (IE); Stefan DECKER, Galway (IE)

Correspondence Address: CROWELL & MORING LLP;INTELLECTUAL PROPERTY GROUP, P.O. BOX 14300, WASHINGTON, DC, 20044-4300, US

(73) Assignee: National University of Ireland, Galway, Galway (IE)

(21) Appl. No.: 12/470,756

(22) Filed: May 22, 2009

(51) Int. Cl. H04L 29/06

(52) U.S. Cl. 726/1

(57) ABSTRACT

A system for annotation-based access control stores a network of interconnected data entities including Person, Resource and Policy entities, each Resource entity designated as being owned by a Person entity. The system enables a user to: define Annotations and to associate the Annotations with stored entities, each Annotation comprising terms defining the sharing of a Resource with Person entities; define Policies having associated Annotation(s); define Actions for each Policy, an action being performed on a Resource; and assign a Policy including an Annotation referring to a Person, a Person Annotation, to selected Resources. The system responds to a request from a user associated with a Person entity to perform an Action on a Resource if the Person satisfies Policies assigned to the Resource i.e. if a Resource is assigned a Policy having a Person Annotation and the Person entity has an Annotation corresponding to the Person Annotation.

### FIELD OF THE INVENTION

The present invention relates to a system for annotation-based access control.

### BACKGROUND

Sharing is a key concept for collaborative information spaces like Web 2.0 or Social Web platforms, for example, Flickr, YouTube, del.icio.us (http://delicious.com) and for Collaborative Work Environments (CWE), for example, BSCW (http://www.bscw.de/), Microsoft SharePoint (http://www.microsoft.com/sharepoint/default.mspx). These platforms and applications provide the infrastructure and services for different types of users to collaborate together and share resources which may vary from songs and photos to documents and calendars. In these Web-based environments involving massive-scale sharing, access control becomes important.

Shen, H., Dewan, P. “Access Control for Collaborative Environments” in Computer-Supported Cooperative Work Conference, 1992, ACM Press: disclose access control mechanisms in a simple collaborative environment, i.e. a simple collaborative text-editing environment.

Zhao, B. Collaborative Access Control, in Seminar on Network Security, 2001: discloses three main access control mechanisms in collaborative environments.

Tolone, W., Ahn, G., Pai, T., Hong, S. Access control in collaborative systems, ACM Computing Surveys, 2005, 37: p. 29-41: disclose access control mechanisms in collaborative systems and compares different mechanisms based on multiple criteria, e.g. complexity, understandability, ease of use.

Jaeger, T., Prakash, A. “Requirements of role-based access control for collaborative systems” in 1st ACM Workshop on Role-based access control, 1996: ACM Press; Ferraiolo, D. F. and Kuhn, D. R. “Role Based Access Control” in 15th National Computer Security Conference, 1992; Sandhu, R. S., Coyne, E. J., Feinstein, H. L. and Youman, C. E., “Role-Based Access Control Models” IEEE Computer, 1996, 29(2): p. 38-47; U.S. Pat. No. 6,202,066, Barkley, J., Cincotta, A. V.; and U.S. Pat. No. 6,640,307, Viets, R. R., Motes, D. G., Greve, P. B., Herberg, W. W., all disclose role-based access control within collaborative systems and social networks.

In RBAC, a user is assigned one or more roles. Each role has some defined permissions. Users receive desired permissions through their roles or they inherit the permissions through the role hierarchy.

Moyer, M. J., Ahamad, M. “Generalized Role-Based Access Control” in ICDCS '01: Proceedings of the 21st International Conference on Distributed Computing Systems, 2001, extend RBAC by introducing subject roles, object roles and environment roles

However, it should be noted that RBAC, GRBAC and other family members of RBAC primarily work well, if there exists well-structured (and perhaps a hierarchy of) roles, permissions (and resources).

Gutierrez Vela, F. L., Isla Montes, J. L., Paderewski, P., Sanchez, M. “Organization Modelling to Support Access Control for Collaborative Systems” in Software Engineering Research and Practice, 2006: disclose modeling an organization in a formal way that considers the necessary elements to represent the authorization and access control policies.

Kern, A., Walhorn, C. “Rule support for role-based access control” in 10th ACM symposium on Access Control Models and Technologies. 2005, ACM Press: provide an architecture for role-based access control to use different rules to extract dynamic roles.

Alotaiby, F. T., Chen, J. X. “A Model for Team-based Access Control” in International Conference on Information Technology: Coding and Computing, 2004, IEEE Computer Society: present a team-based access control building upon role-based access control.

Periorellis, P., Parastatidis, S. “Task-Based Access Control for Virtual Organizations” in Scientific Engineering of Distributed Java Applications, 2005: introduce another extension to role-based access control which is called task-based access control. They discuss task-based access control as a mechanism for dynamic virtual organization scenarios.

Toninelli, A., Bradshaw, J., Kagal, L., Montanari, R. “Rule-based and Ontology-based Policies: Toward a Hybrid Approach to Control Agents in Pervasive Environments” in Semantic Web and Policy Workshop, 2005: disclose combining rule-based and ontology-based policies in pervasive environments.

Demchenko, Y., Gommans, L., Tokmakoff, A., van Buuren, R. “Policy Based Access Control in Dynamic Grid-based Collaborative Environment” in International Symposium on Collaborative Technologies and Systems, 2006, IEEE Computer Society: disclose an access control model and mechanism for grid-based collaborative applications.

Hart, M., Johnson, R. and Stent, A. “More Content—Less Control: Access Control in the Web 2.0” in Web 2.0 security and privacy issues, IEEE Symposium on Security and Privacy, 2007: show that current access control mechanism within Web 2.0 platforms and shared workspaces suffer from fine-granularity. As an example, users are able to share a resource with some colleagues, but specific conditions (such as for a particular time or within a certain context) cannot be expressed. This shortcoming undermines the utility of shared workspaces and brings privacy-related issues in Web 2.0 platforms. As a result, users sometimes use email and instant messaging to share confidential resources with each other yielding an overhead as well as versioning control problems for users.

At the same time, annotation is a common mechanism, which is nowadays used by social network platforms for labeling shared information resources. Annotation is based on mechanisms that allow users to describe resources with “tags”. In this way, users are allowed to attach metadata to commonly shared resources (social tagging). These tags later facilitate browsing and discovery of relevant resources.

Carminati, B., Ferrari, E. and Perego, A. “Rule-Based Access Control for Social Networks”, in OTM Workshops (2), 2006; and Kruk, S. R., Grzonkowski, S., Gzella, A., Woroniecki, T. and Choi, H. C. “D-FOAF: Distributed Identity Management with Access Rights Delegation” in Asian Semantic Web Conference, 2006: disclose a distributed identity management system for social networks. Using information inherent in social networks, access rights delegation can be community driven with appropriate authorisation and access rights checking.

It is an object of the present invention to provide an annotation-based access control system to address access control requirements in social and collaborative platforms.

### SUMMARY OF THE PRESENT INVENTION

According to a first aspect of the present invention there is provided a system for annotation-based access control according to claim 1.

In a second aspect of the present invention there is provided a system for annotation-based access control according to claim 16.

In a third aspect of the present invention there is provided a system for annotation-based access control according to claim 17.

In a fourth aspect of the present invention there is provided a system for annotation-based access control according to claim 18.

While the present invention enables users to annotate their resources such as used in various social media sites (like Flickr and del.icio.us), the present invention further enables users to annotate their contacts and define access control policies based on those annotations. Thus, annotations are more “powerful”, as they may benefit from attributes and values. Annotations can be either explicit or implicit to be assigned dynamically to increase their flexibility. Moreover, the model underlying the system enables users to benefit from explicit and implicit context information of persons and resources in the policies. A policy itself can also have context information.

At this point, we would clarify the terms “group” and “role”. A group is a named collection of users and possibly other groups. Role differs from group, as role is either a named collection of users, permissions, and possibly other roles; or a named collection of permissions, and possibly other roles.

The main difference between RBAC and the present invention is that in RBAC, roles are already defined by a role engineer, but according to the present invention, annotations which are not necessary roles (from the semantics point of view) are decentralized. It is the user that defines his/her own annotations and assigns them to his/her contacts which is more user-centric. Annotations differ from roles, as an annotation does not keep permissions. From the RBAC perspective, the present invention can be seen as an extension to RBAC through assigning user-centric or bottom-up versus top-down roles (i.e. annotations) without any permissions to a person's contacts and resources. The other main difference is the concept of Distance which increases or decreases the scope of policies in sharing resources, as people are connected together in a graph-like manner (rather than hierarchy-like manner).

The present invention is more dynamic and flexible through introducing implicit concepts (i.e. implicit annotation, implicit context and implicit values of attributes). Where RBAC can be very useful in large and well-structured organizations, the present invention fits well for defining access control policies for more ad hoc social networks such as those emerging through social platforms and CWEs. As such the present invention fits well for sharing personal data with personal contacts.

It is noted that social networking sites like Facebook enable users to assign their contacts to various groups. However, annotation-based access control according to the present invention differs from such group-based access control. First, we have the concept of implicit annotations which enable users to set the annotations at run-time. Second, we have a Distance criterion, which increases or decreases the scope of annotations in policies. Third, users may define different access control policies based on various actions. Fourth, users may benefit from explicit and implicit context information of their contacts and resources to assign more flexible policies. Fifth, an annotation can be tuned using attribute and value pairs. Finally, from the definition point of view, a group is usually non-empty, and will typically have at least two members, whereas an Annotation can be assigned freely to just one person.

By contrast with the present invention, approaches such as Carminati et al, and Kruk et al do not completely support various attributes and values for annotations. Second, they do not support implicit and explicit annotations. Third, they do not use any explicit or implicit context information for defining access control policies. Fourth, they do not enable users to define different access control policies for various actions, and finally they do not enable users to use open as well as closed vocabulary.

### BRIEF DESCRIPTION OF THE DRAWINGS

An embodiment of the invention will now be described, by way of example, with reference to the accompanying drawings, in which:

FIG. 1 shows the main elements and their relationships of a model underlying a system for context-aware annotation-based access control according to a preferred embodiment of the present invention;

FIG. 2 shows a use case scenario for the model of FIG. 1;

FIG. 3 is a snapshot showing a user interface component of a system enabling a user to interact with a data store based on the model of FIG. 1; and

FIG. 4 shows the overall system architecture.

### DESCRIPTION OF THE PREFERRED EMBODIMENT

In the access control model underlying the preferred embodiment of the present invention, end users are able to annotate their contacts (social network) and resources (e.g. bookmarks, photos, documents) and define policies for granting access to their resources based on these annotations. In this context, only those contacts that fulfill the required policies get access to specific resources.

For example, User A owns several resources (e.g. documents) which have been tagged as Research_Paper. User A annotates user B, who is part of her social network, as Collaborate_With. User A defines an access control policy to share the resources that have been tagged as Research_Paper with her contacts that have been tagged as Collaborate_With. In this case, the system of the present invention enables all appropriate resources to be automatically accessible to the user B, as user B meets the policy requirements.

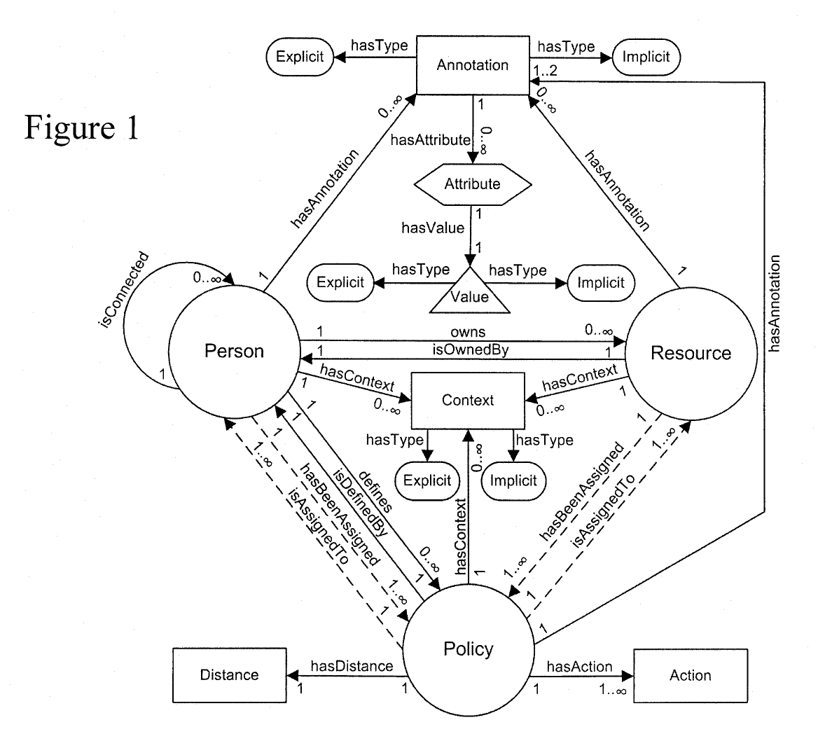

Referring now to FIG. 1, which shows the elements and relationships of the access control model underlying the system of the present embodiment. The access control model comprises three main entities Person, Resource, and Policy and four main concepts: Annotation, Distance, Context, and Action:
In the present embodiment, a Person is an entity with the RDF type Person. (RDF represents knowledge in the form of subject-predicate-object notion. However, it will be seen that RDF is simply one example of data model which could be used for the entities and concepts of the invention and could be replaced with other data models.) A Person is connected unidirectionally to zero or more other Person(s) and the source Person can tag the target Person with zero or more Annotation(s). A Person owns zero or more Resource(s). A Person defines zero or more Policy(ies). A Person may, i.e. it is conditional, be assigned (hasBeenAssigned) one or more Policy(ies) by other Person(s). A Person has zero or more Context(s) that aim to describe the context information of that Person.
A Resource is an entity with the RDF type Resource and is owned by (isOwnedBy) one Person. Note that a single Resource (with different IDs) can be conceptually owned by more than one Person. A Resource is online material, for example, a photo or bookmark, although, the model can be applied to an offline (e.g. key) Resource as well. A Resource owner can assign zero or more Annotation(s) to a Resource. A Resource may be assigned (hasBeenAssigned) one or more Policy(ies) by Resource owner. A Resource can conceptually be either private or public. A private Resource has either zero Policy(ies) or the Policy(ies) that are never matched with any specified Annotation(s), Distance(s), and/or Context(s); whereas a public Resource has one or more Policy(ies) which will be met (matched) at some point. A Resource has zero or more Context(s) that aim to describe the context information of that Resource.
A Policy is an entity with the RDF type Policy. A Policy is defined by (isDefinedBy) one Person. A Policy may be assigned to (isAssignedTo) one or more Resource(s). A Policy may be assigned to (isAssignedTo) one or more Person(s). A Policy has at least one and at most two Annotation(s). A Policy has one Distance. A Policy has at least one Action. A Policy has zero or more Context(s) that aim to describe the context information of a Person, Resource or that Policy.
An Annotation is a term or set of terms that are connected together and aims to describe the Person(s) or the Resource(s) that the Resource(s) should be shared with. An Annotation can be (hasType) either Explicit or Implicit. An Explicit Annotation is a fixed term or set of terms that are assigned by a Person to a Person, Resource or for defining a Policy. An Implicit Annotation may be a term or set of terms. An Implicit Annotation is calculated and/or assigned during run-time. As an example, an Implicit Annotation may be the output of a Web service which is invoked at run-time. An Annotation can have zero or more Attribute(s). An Attribute has one Value and is a criterion to “tune” the Annotation (e.g. friend is an Annotation which can be assigned with an Attribute like reliability and a Value like very high). The Value of an Attribute can be assigned statically (Explicit) or dynamically (Implicit). For example, an Implicit Value may be the result of a Web service which is invoked at run-time.
A Distance is a numerical value which determines the depth or extent across a network of connected entities for which the Policy is valid. The depth is length of the shortest path among two Person(s) with consideration of Annotation(s), between Person(s) connected in a graph-like manner.
A Context represents the context information of an entity. Defining context information is domain (implementation) dependant. Theoretically, context information of an entity can contain “anything” regarding that entity (e.g. status, profile). Context is either Explicit or Implicit. An Explicit Context refers to that context information which is assigned to or manually specified at any time. An Implicit Context is calculated and/or assigned during run-time. As an example, an Implicit Context may be the output of a Web service which is invoked at run-time. A Person can assign an Explicit Context to himself/herself (e.g. traveling). A Resource can have context information (e.g. size, modification date, source). A Policy can also have context information (e.g. Context of a Policy may determine the validity period of that Policy; or a Policy may be enabled/disabled by setting an Explicit Context of that Policy to True/False). Note that Context of a Person is set by that Person (or can be fetched considering the status of that Person); Context of a Resource is set by the Resource owner (or can be fetched considering the status of that Resource); and Context of a Policy is set by the Person that defines the Policy.
An Action is an event (function) that can happen on a Resource (e.g. Read, Revise, Copy, Delete, Synchronize, Archive etc.)

For the purposes of the present specification, there are several definitions.
Definition 1: A policy is called an Explicit Policy, if all of its Annotation(s) and Context(s) are Explicit.
Definition 2: A policy is called an Implicit Policy, if all of its Annotation(s) and Context(s) are Implicit.
Definition 3: The Annotation used in a Policy is called a Person Annotation, if it refers to Person(s).
Definition 4: The Annotation used in a Policy is called a Resource Annotation, if it refers to Resource(s).
Definition 5: A Context is called a Person Context, if it describes the context information of a Person.
Definition 6: A Context is called a Resource Context, if it describes the context information of a Resource.
Definition 7: A Context is called a Policy Context, if it describes the context information of a Policy.

There exist several rules (meta-policies) which are useful for implementing systems based on the model:
Rule 1: A Person acquires access to a Resource, if and only if (iff) s/he meets all or part of the Policy(ies) that have been defined by the Resource owner for that Resource.
Rule 2: Only the Resource owner is eligible to define Policy(ies) for the Resource(s) that s/he owns.
Rule 3: If a Policy has one Annotation and if that Annotation is a Person Annotation, then the Policy must be assigned to (isAssignedTo) one or more Resource(s). In this case, those Resource(s) become assigned (hasBeenAssigned) to that specified Policy.
Rule 4: If a Policy has one Annotation and if that Annotation is a Resource Annotation, then the Policy must be assigned to (isAssignedTo) one or more Person(s). In this case, those Person(s) become assigned (hasBeenAssigned) to that specified Policy.
Rule 5: Distance belongs to Person Annotation.
Rule 6: Distance is calculated taking Annotation(s) into account. Annotation(s) are used to build a graph among people which may contain several paths between two Person(s) and preferably all paths are considered when determining how to reach a target Person from a source Person. For example, if Person A is connected to Person B and has annotated Person B with student, the Distance from Person A to B (unidirectional) with the consideration of student is one. The Distance from Person A to B (unidirectional) with the consideration of any other Annotation (e.g. friend) is infinity. The Distance from Person B to A (unidirectional) is also infinity, if Person B has not defined an outgoing link to Person A.
Rule 7: Distance should be considered/calculated/enabled for just commonly-agreed Annotation(s) with commonly-agreed meanings, otherwise it may lead to misunderstanding of some concepts.
Rule 8: Each Person, Resource, and Policy should be uniquely identifiable.
Rule 9: A Person may assign Annotation(s) to other Person(s), but s/he may define Context for himself/herself (i.e. self-Annotation).
Rule 10: The Value of an Attribute needs to be based on a pre-defined scale (e.g. “1” to “10” or “very low” to “very high”).
Rule 11: A Resource/Policy/Person may be removed or edited by the owner. Removing/editing an entity affects also all belonging components.
Rule 12: Policy(ies) may complement each other, but may not have conflicts with each other.

Some implementation guidelines are as follows:
Action(s) may be originated from an ontology that models the possible events (functions) that can happen on a resource.
It is up to the implementer to decide how to enable the Action(s).
Annotation(s) may not be case-sensitive.
Policy(ies) may support mathematical operators (e.g. ternary operators, logical operators, relational operators).
The shortest path from one Person to another may be calculated using various methods and algorithms (e.g. Dijkstra's algorithm).
It is up to the implementer to define the skeleton and framework in which an Implicit Annotation may be defined and/or fetched.
It is up to the implementer to enable Person(s) to prioritize the Policy(ies) since the order in which Policy(ies) are considered may be important for users.
It is up to the implementer to choose appropriate and domain-specific closed vocabulary(ies) that can be used for Person Annotation. It is also up to the implementer to recommend/propose suitable Annotation(s) based on the closed vocabulary(ies) to Person(s) (e.g. based on statistical results).
It is up to the implementer to choose an appropriate way to prompt Person(s) for the availability of a new Resource (e.g. RSS feed, instant messaging).
Note that some Policy(ies) can be merged/aggregated to simplify the representation of those Policy(ies) (e.g. A simplified Policy may have more than two Annotations(s)). A Policy can be expressed/represented using the following syntax: (Resource Annotation: [Attribute: Value, . . . ]) . . . : Resource Context, . . . ; (Person Annotation: Distance: [Attribute: Value, . . . ]) . . . : Person Context, . . . ; Action, . . . ; Policy Context, . . . . Note that for simplicity, mathematical operators are not included in the Policy representation in the above syntax; nonetheless, mathematical operators may be used in Annotation(s), Attribute(s) and Value(s), Action(s) and Context(s).
If the Value of an Attribute has not been explicitly mentioned in a Policy, then the minimum Value may be considered.
Semantic match-making of Annotation(s) may be considered in Policy evaluation (specially for commonly-agreed vocabulary(ies)) (e.g. a closeFriend is a friend as well).
It is recommended to disable Attribute(s) for Distance(s) greater than one. If the implementer decides to enable Attribute(s) for the Distance(s) greater than one, then it should be considered for just commonly-agreed vocabulary(ies) with commonly-agreed meanings, as Distance is enabled for just commonly-agreed vocabulary(ies). In this case, it is necessary to agree on Attribute(s) as well as their meanings. When users agree on Annotation(s) and Attribute(s), it is the responsibility of the implementer to select the appropriate algorithm to calculate Value(s) in transitive relationships.
It is up to the implementer to define a domain-dependant context model and enable this model in this access control approach
It is up to the implementer to define the skeleton and framework that an Implicit Context may be defined and/or fetched.
Distance(s) and Action(s) could also have Explicit or Implicit types (i.e. values). However, it may not make sense to “dynamically” assign Action(s) and Distance(s), as this may increase the complexity of the model and also decrease the security and privacy.
The default Distance for Person Annotation(s) in the Policy(ies) may be “one”.
The default Action may be “Read”.
The default mathematical operator between Attribute(s) and Value(s) may be “Equality”.
A user may have the choice to make a Resource publicly available for the whole network or the whole Person(s) (with any Annotation(s)) within the scope of a specific Distance.
It is up to the implementer to remove some part of the Annotation-Based Access Control model (e.g. Attribute and Value) to reduce its complexity.

Some privacy guidelines are as follows:
A Person may opt-out, for himself/herself or his/her contacts, of being included in the shortest path algorithm. In other words, a Person can control the scope of resources that are shared with friends of friends through friends via Distance.
A Resource owner may give access to his/her Resource(s), either if all Policy(ies) are met, or if some of them are met. In other words, s/he may decide whether the Policy(ies) need to be ANDed or ORed.
All Resource Annotation(s) and part of the Person Annotation(s) that are not based on a commonly-agreed vocabulary should be private, unless a Person agrees to share them with others. The reason that commonly-agreed Person Annotation(s) can not be private is simply the fact that there is a so-called “hack” to somehow reveal them. For example, suppose that Person X has annotated Person Y with an Explicit Annotation K (based on a commonly-agreed vocabulary). Person Y has also annotated person Z with an “unknown” Annotation. If person X shares Resource W with those Person(s) that have been annotated with K and Distance 2; then if Person Z has access to Resource W via Person X, we may conclude that Person Z has been also annotated with Explicit Annotation K by Person Y.
Unidirectional connection between two Person(s) should require acceptance confirmation by the target Person.

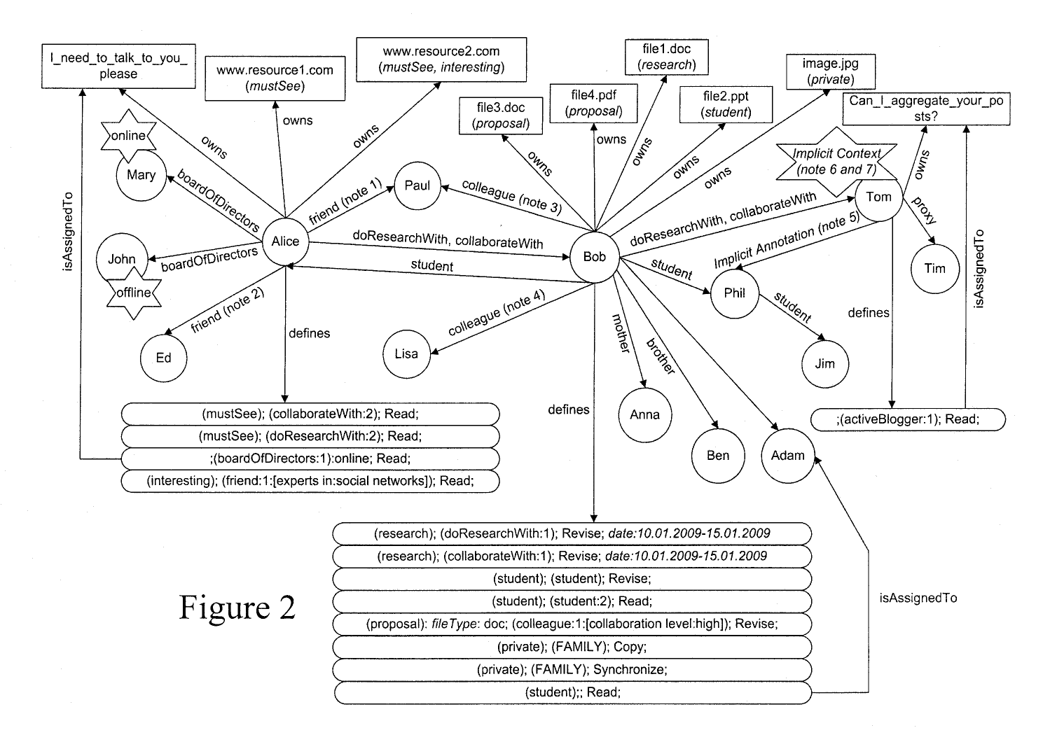

Referring now to FIG. 2, where for simplicity return arrows are not shown in the figure, several users are connected together, but Alice, Bob and Tom are major players. The default Distance is “1” and default action as “Read”. The policy representation presented as an implementation guideline above is used (We use a semicolon (;) for separating annotations and actions in the policies; a colon (:) for separating person annotation and distance; etc.)

Users perform the following actions: Alice adds the following people to her social network:
She adds Bob and annotates him with two explicit annotations: collaborateWith and doResearchWith. We suppose these two explicit annotations originate from a commonly-agreed vocabulary with commonly-agreed meaning.
She adds Mary to her contacts and annotates her with one explicit annotation: boardOfDirectors.
She adds John to her contacts and annotates him with one explicit annotation: boardOfDirectors.
She adds Paul to her contacts and annotates him with an explicit annotation: friend. As per note 1, for tuning purposes, Alice also defines an attribute called “experts in” for this annotation. From the technical point of view, she points out to a Web service that returns expertise of a user, as an implicit value for this attribute.
She adds Ed to her contacts and annotates him with an explicit annotation: friend. As per note 2, in order to tune this annotation, Alice defines an attribute called “experts in” for this Annotation as well. She defines an implicit value for this attribute which points out to a Web service.

Alice owns the following resources:
A bookmark: www.resource1.com with one explicit annotation: mustSee.
A bookmark: www.resource2.com with two explicit annotations: mustSee and interesting.
A short message: I_need_to_talk_to_you_please.

Alice defines the following policies.
policy1: (mustSee); (collaborateWith:2); Read;. This policy gives Read access of all resources that have been annotated as mustSee, to people that have maximum distance of 2 (i.e. connections of connections) to Alice, and have been annotated as collaborate With (i.e. a term which originated from a vocabulary).
policy2: (mustSee); (doResearchWith:2); Read;. This policy gives Read access of all resources that have been annotated as mustSee, to people that have maximum distance of 2 to Alice, and have been annotated as doResearchWith.
policy3: ;(boardOfDirectors:1):online; Read; for I_need_to_talk_to_you_please resource. This policy has no “Resource Annotation”; therefore it needs to be attached to a single or multiple resources. This policy means that those direct contacts of Alice that have been annotated as boardOfDirectors and their context information express that they are online, have Read access to I_need_to_talk_to_you_please.
Policy4: (interesting); (friend:1:[experts in: social networks]); Read;. This policy gives Read access to all resources that have been annotated as interesting, to direct “friend”(s) of Alice, who are “expert(s) in” “social networks”.

Alice also defines that, in order to access a resource, a person should meet all policies that have been assigned to that resource.

Bob adds the following people to his social network:
He adds Alice and annotates her with one explicit annotation: student. We suppose this explicit annotation comes from a commonly-agreed vocabulary with commonly-agreed meaning.
He adds Tom and annotates him with two explicit annotations: collaborate With and doResearchWith. We assume that these two explicit annotations originate also from a commonly-agreed vocabulary with commonly-agreed meaning.
He adds Ben to his contacts and annotates him with one explicit annotation: brother. We assume that this explicit annotation comes from a commonly-agreed vocabulary with commonly-agreed meaning.
He adds Anna to his contacts and annotates her with one explicit annotation: mother. We assume that this explicit annotation comes from a commonly-agreed vocabulary with commonly-agreed meaning.
He adds Phil to his contacts and annotates him with one explicit annotation: student. As stated, this annotation comes from a commonly-agreed vocabulary with commonly-agreed meaning.
He adds Paul to his contacts and annotates him with an explicit annotation: colleague. As per note 3, in order to tune this annotation, Bob defines an attribute called “collaboration level” for that. He also sets an explicit value for this attribute: high.
He adds Lisa to his contacts and annotates her with an explicit annotation: colleague. Bob also defines an attribute called “collaboration level” for this annotation. As per note 4, he also sets an explicit value for this attribute: low.
He adds Adam to his contacts and does not annotate him.

Bob owns the following resources:
A document: file1.doc with an explicit annotation: research
A document: file2.ppt with an explicit annotation: student
A document: file3.doc with an explicit annotation: proposal
A document: file4.pdf with an explicit annotation: proposal
An image: image.jpg with an explicit annotation: private

Bob defines the following policies for his resources and sets that in order to access a resource, a person should meet all policies belonging to the resource.
Policy5: (research); (doResearchWith:1); Revise; date:10.01.2009-15.01.2009. This policy gives Revise access to all resources that have been annotated as research, to people that have maximum distance of 1 to Bob (i.e. direct connection), and have been annotated as doResearchWith. This policy has a validity period (i.e. Policy Context). The validity period is from 10.01.2009 to 15.01.2009.
Policy6: (research); (collaborateWith:1); Revise; date:10.01.2009-15.01.2009. This policy gives Revise access to all resources that have been annotated as research, to people that have maximum distance of 1 to Bob (i.e. direct connection), and have been annotated as collaborate With. This policy has a validity period (i.e. Policy Context). The validity period is from 10.01.2009 to 15.01.2009.
Policy7: (student); (student); Revise;. This policy gives Revise access to all resources that have been annotated as student, to people that have maximum distance of 1 (i.e. default distance) to Bob (i.e. direct connection), and have been annotated as student.
Policy8: (student); (student:2); Read;. This policy gives Read access to all resources that have been annotated as student to people that have maximum distance of 2 (i.e. connections of connections) to Bob, and have been annotated as student.
Policy9: (proposal): fileType: doc; (colleague:1:[collaboration level:high]); Revise;. This policy gives Revise access to all resources that have been annotated as proposal and have doc fileType (i.e. Resource Context), to people that have maximum distance of 1 to Bob (i.e. direct connection) and have been annotated as colleague, and their “collaboration level” (i.e. attribute) is “high” (i.e. value).
Policy10: (private); (FAMILY); Copy;. This policy gives Copy access to all resources that have been annotated as private, to people that have maximum distance of 1 to Bob (i.e. direct connection), and have been annotated as an implicit annotation: FAMILY. We assume that this annotation comes from a commonly-agreed vocabulary with commonly-agreed meaning that models the members of a “family”. In other words, the members of a family (e.g. brother, mother) will be calculated at run time. The reason that Bob capitalized this annotation is to emphasize the implicitness of the annotation.
Policy11: (private); (FAMILY); Synchronize;. This policy gives Synchronize access to all resources that have been annotated as private, to people that have maximum distance 1 to Bob (i.e. direct connection), and have been annotated implicitly as FAMILY which originates from a commonly-agreed vocabulary with commonly-agreed meaning and should be matched at run-time.
Policy12: (student);; Read;. This policy gives Read access of the resources that have been annotated as student, to specified person(s). This policy has no “Person Annotation” and is conceptually attached to one person (isAssignedTo) Adam.

Tom adds the following people to his contacts:
He adds Phil to his contacts and annotates him with an implicit annotation. As per note 5, in order to set an implicit annotation, Tom defines the following rule: If Phil has updated his blog in the past one month, then he is annotated as activeBlogger, otherwise inactiveBlogger.
He adds Tim to his contacts and annotates him with an explicit annotation which comes from a vocabulary with commonly-agreed meaning: proxy.

Tom owns also one resource (i.e. short message): Can_I_aggregate_your_posts?. He also defines the following access control policy for this resource:
Policy13: ;(activeBlogger:1); Read;. This policy means Read access of the specified resource is allowed to direct contacts of Tom (i.e. distance of 1) that have been annotated as activeBlogger. This policy has no “Resource Annotation” and is conceptually attached to one resource (isAssignedTo).

As per note 6, Tom defines some implicit context elements for himself using some rules: If I am not online in my IM client, then I am “traveling”, otherwise I am “notTravelling” (i.e. in the office). As per note 7, he also defines that: If I am “traveling”, then my contacts that have been annotated as proxy are eligible to access the same non-private resources. This concept (i.e. private) originates from a commonly-agreed vocabulary with commonly-agreed meaning.

Phil adds Jim to his contacts and annotates him with an explicit annotation: student. We suppose this explicit annotation comes from a commonly-agreed vocabulary with commonly-agreed meaning. Phil does not own any resources. He does not define any context elements for himself.

The other users (i.e. Mary, John, Paul, Ed, Lisa, Anna, Ben, Tim and Jim) do not add any specific contacts or resources. But Mary and John, who have been annotated as boardOfDirectors by Alice define context information for themselves. Mary sets a context element for herself: online; and John sets a context element for himself: offline.

Considering above connections and policies, we have granted access to the followings persons/resources:
Clearly, each resource owner has full access to his/her resources.
Alice has Read and Revise access to file2.ppt via Bob, because file2.ppt is accessible to Bob's contacts that have been annotated as student and who have a maximum distance of one or two to Bob. Alice fulfills this policy. The distance is a parameter that was used by Bob to tune the actions in the policy.
Bob has access to two of Alice's resources: www.resource1.com and www.resource2.com, as he fulfils the required policies.
Mary has Read access to the short message of Alice, I_need_to_talk_to_you_please, as she is online.
John will not have Read access to the short message of Alice, as he is offline and does not meet the policy.
Paul may gain Read access to www.resource2.com via Alice, as he has been annotated with an annotation (i.e. friend) which has been tuned by an attribute and an implicit value. In other words, in the case of a request, Paul's expertise will be extracted and if he has sufficient expertise (i.e. in social networks), he will gain access to the specified resource. Paul also has Revise access to file3.doc via Bob, as his collaboration level with Bob is “high” (as explicitly mentioned by Bob).
Ed may gain Read access to www.resource2.com via Alice, as he has been annotated with an annotation (i.e. friend) which has been tuned by an attribute and an implicit value. Like Paul, Ed's expertise is calculated at run-time.
Lisa does not have any access to Bob's resources, as his collaboration level is “low” (as explicitly mentioned by Bob).
Anna has Copy and Synchronize access to image.jpg via Bob, as she has been annotated as mother and based on the predefined vocabulary, “mother” is part of the “FAMILY” and she fulfills the requirements.
Ben has Copy and Synchronize access to image.jpg via Bob, as he has been annotated as brother and based on the predefined vocabulary, “brother” is part of the “FAMILY” and he fulfills the requirements.
Tom has Revise access to file1.doc which is shared via Bob to him and also Read access to www.resource1.com and www.resource2.com which are shared via Alice to him.
Phil has Read and Revise access to file2.ppt via Bob. Phil may also gain access to this message: Can_I_aggregate_your_posts? via Tom, if he has updated his blog in the past month.
Jim has Read access to file2.ppt via Bob, but he does not have Revise access to that file, as his distance to Bob is 2.
Tim may gain access to whatever that Tom has access, in case Tom is “traveling” (i.e. not in the office). Tim will not have access to Tom's private resources.
Adam has Read access to file2.ppt via Bob.

The technologies for enabling the above implicit annotations, rules, context elements, and commonly-agreed vocabularies include, for example, Web services, Semantic Web technologies, and the APIs of IM clients.

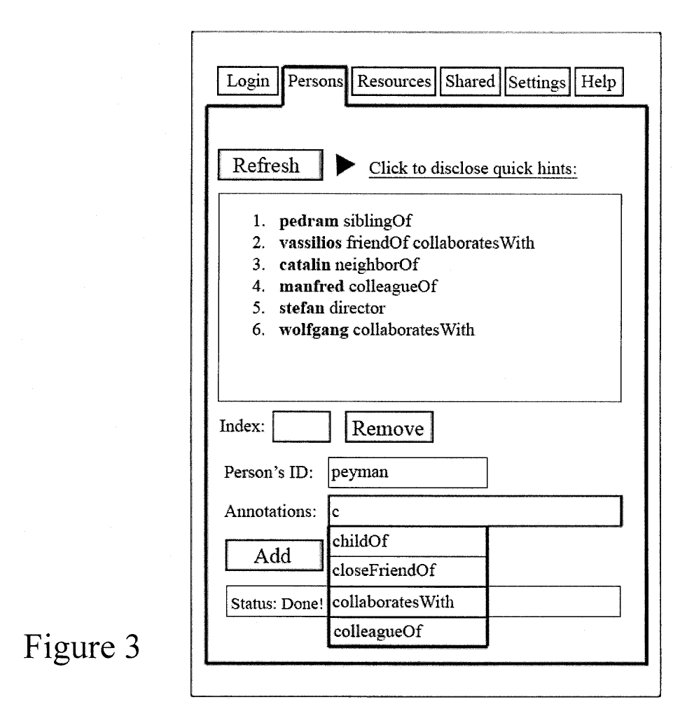

FIG. 3, shows a user-interface component for a system implementing the present invention. The component has six main tabs: Login, Persons, Resources, Shared, Settings, and Help. It will of course be appreciated that either this component would need to be extended or additional components provided to enable a user to fully operate a system based on the model of FIG. 1. Nonetheless, in relation to this component:
All users subscribe first via the Login tab. The subscription is pretty straightforward. The current registration requires just full name, user name and password.
Under the Persons tab, users are able to add contacts, annotate them, and remove some of their contacts.
Under the Resources tab, users are able to add various resources (URLs/URIs/short messages) and assign different sharing policies to them.
Under the Shared tab, users are able to see the resources that have been shared by others. They can set the distance to increase or decrease the scope of the shared resources.
Under the Settings tab, end users are able to change the server and change their passwords. The server (SOA server) is a Java WAR file which can be installed on any machine and end users can have their own instances of SOA server.
Under the help tab, there exists a link to the tutorial video and some technical and contact information regarding the platform.

The component runs as a Service-Oriented Architecture (SOA) application, see Papazoglou, M. P., Traverso, P., Dustdar, S. and Leymann, F. “Service-Oriented Computing: State of the Art and Research Challenges”, Computer, 2007, 40: p. 38-45 for more information on SOA. In SOA, internal system functionalities are packaged as services and become accessible via end points to end users. All functionalities of the component (registration, changing password, adding persons and resources, fetching shared resources, etc.) are wrapped as Web services. This approach enables developers to utilize all the component's functionalities within their own separate applications, ensuring reusability and interoperability with various platforms.

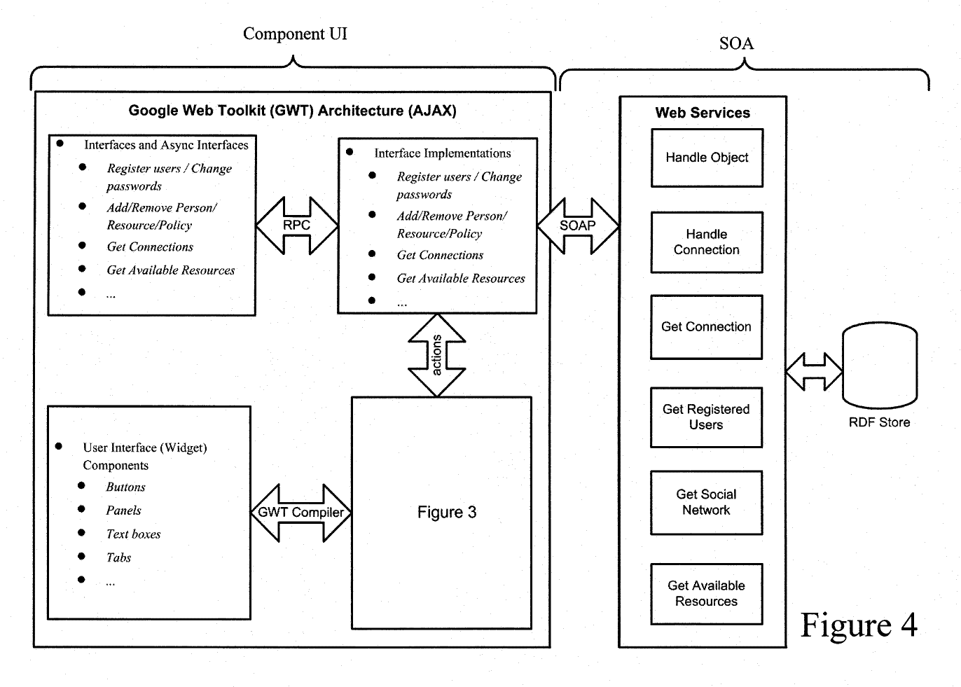

Referring to FIG. 4, the component in its current implementation provides the following services:
Handle Object: This service enables end users to register themselves to the system and/or change their passwords.
Handle Connection: This service enables end users to add connections between persons; persons and resources; and persons and policies. This service also enables end users to annotate the connections between persons with closed and/or open terms. We used RELATIONSHIP (http://purl.org/vocab/relationship/) ontology as a commonly-agreeed closed vocabulary. RELATIONSHIP is an extended version of FOAF (http://www.foaf-project.org/) and a set of terms for describing general relationships between people.
Get Connection: This service enables end users to get who/what is connected to a specific person.
Get Registered Users: This service returns the list of the registered users on the system.
Get Social Network: This service returns the social network of the authenticated user in RDF.
Get Available Resources: This service returns the available resources to a specific person based on the Distance input.

In one implementation, the component uses Sesame 2.0 (http://www.openrdf.org/) as an RDF repository to store the generated RDF triples. The SOA backbone is based on Apache CXF (http://incubator.apache.org/cxf/) which eases the development of Web services. Google Web Toolkit (GWT) (http://code.google.com/webtoolkit/), a free Java package, is used for building the AJAX-based component (referred to as a gadget), as it gives the basic useful elements of the UI, such as text boxes, buttons, tabs, etc.

The embodiment described above comprises an Annotation-Based Access Control model applicable in multiple Web-based collaborative information spaces like Web 2.0 social platforms (e.g. Flickr, YouTube, del.icio.us) and/or Collaborative Work Environments (CWE) (e.g. BSCW, Microsoft SharePoint). Other implementations of the invention could use the Open Social API to embed the invention into social networking sites such as MySpace and Orkut. Open Social follows the idea of Write once, run anywhere and enables developers to develop cross-platform applications among social Web sites.

It will be seen that the above embodiment may be extended to include, for example, more advanced user models, suggestions/recommendations for access policies, and access policy prioritization.

1. A system for annotation-based access control, said system being arranged to store a network of interconnected data entities, said entities including Person, Resource and Policy, wherein each Resource entity of said system is designated as being owned by a Person entity, said system being arranged to enable a user associated with a Person entity of said system to:
define an Annotation and to associate said Annotation with an entity stored by said system, said Annotation comprising one or more terms at least partially defining the sharing of Resource entities with Person entities within said system;
define at least one Policy, each policy having at least one associated Annotation;
define a Distance for each Policy, said Distance corresponding to a number of links between two Person entities within said network for which said Policy is valid;
define at least one Action for each Policy, an action being performed on a Resource; and
associate a Policy including an Annotation referring to one of a Person or a Resource to the other of selected stored Resources or Persons; and
said system being responsive to a request from a user associated with a Person entity to perform an Action on a Resource if said Person satisfies at least part of any Policies that are associated with said Resource or said Person, a Policy being satisfied at least if said Resource or said Person is associated with a Policy having an Annotation and the other of said Person or said Resource entity has an Annotation corresponding to said Policy Annotation and said Person is within a Distance from another Person entity specified by said Policy.

2. A system as claimed in claim 1 being arranged to enable a user to:
define at least one Context for at least one entity stored by the system; and
said system being arranged to determine that a Policy for a Resource is satisfied if said Resource is associated with a Policy having a Context and said Person has a Context corresponding to said Resource Policy Context.

3. A system as claimed in claim 1 being arranged to enable a user to:
define a Policy including a Resource Annotation referring to a Resource and a Person Annotation referring to a Person, said defined Policy being satisfied at least if a Person requesting access to a Resource is assigned an Annotation corresponding to a Person Annotation of said assigned Policy and if said Resource is assigned an Annotation corresponding to a Resource Annotation of said assigned Policy.

4. A system as claimed in claim 1 being arranged to enable a user to:
assign a Policy including a Resource Annotation referring to a Resource to a Person, said assigned Policy being satisfied at least if said Resource is assigned an Annotation corresponding to said Resource Annotation of said Policy assigned to a requesting Person.

5. A system as claimed in claim 1 being arranged to enable a user to:
assign a Policy including a Person Annotation referring to a Person to a Resource, said assigned Policy being satisfied at least if said Person is assigned an Annotation corresponding to said Person Annotation of said Policy assigned to a requested Resource.

6. A system as claimed in claim 1 being arranged to enable a user to define both an Implicit Annotation, whose value is calculated at system run-time, or an Explicit Annotation, comprising a fixed set of terms.

7. A system as claimed in claim 2 being arranged to enable a user to define both an Implicit Context, whose value is calculated at system run-time, or an Explicit Context, comprising information manually assigned by said user.

8. A system as claimed in claim 7 wherein an Implicit value comprises an output of a Web service invoked at system run-time.

9. A system as claimed in claim 7 arranged to enable a user to assign a Context to their Person entity.

10. A system as claimed in claim 1 arranged to enable a user to assign a Context to a Policy, said Policy being satisfied at least if at a time of said request, said Context is satisfied.

11. A system as claimed in claim 1 arranged to enable a user to assign an Attribute to an Annotation, said Attribute having a value, a Policy including an Attribute value for an Annotation being satisfied if said requesting Person or said requested Resource has an Attribute Value for an Annotation corresponding to said Policy Annotation Attribute Value.

12. A system as claimed in claim 11 arranged to enable a user to assign either a statically assigned Explicit value or a run-time generated Implicit value to an Annotation Attribute.

13. A system as claimed in claim 1 wherein each Resource comprises either online or offline material.

14. A system as claimed in claim 1 wherein said system is arranged to designate a Resource without an Annotation as Private.

15. A system as claimed in claim 1 wherein an Action includes one of a group including: Read, Revise, Copy, Delete, Synchronize, Archive to be performed on a Resource.

16. A system for annotation-based access control, said system being arranged to store a network of interconnected data entities, said entities including Person, Resource and Policy, wherein each Resource entity of said system is designated as being owned by a Person entity, said system being arranged to enable a user associated with a Person entity of said system to:
define an Annotation and to associate said Annotation with an entity stored by said system, said Annotation comprising one or more terms at least partially defining the sharing of Resource entities with Person entities within said system;
define at least one Policy, each policy having at least one associated Annotation;
define at least one Context for at least one entity stored by the system;
define at least one Action for each Policy, an action being performed on a Resource; and
associate a Policy including an Annotation referring to one of a Person or a Resource to the other of selected stored Resources or Persons; and
said system being responsive to a request from a user associated with a Person entity to perform an Action on a Resource if said Person satisfies at least part of any Policies that are associated with said Resource or said Person, a Policy being satisfied at least if said Resource or said Person is associated with a Policy having an Annotation and the other of said Person or said Resource entity has an Annotation corresponding to said Policy Annotation and said Policy has a Context and said Person or Resource has a Context corresponding to said Policy Context.

17. A system for annotation-based access control, said system being arranged to store a network of interconnected data entities, said entities including Person, Resource and Policy, wherein each Resource entity of said system is designated as being owned by a Person entity, said system being arranged to enable a user associated with a Person entity of said system to:
define an Annotation and to associate said Annotation with an entity stored by said system, said Annotation comprising one or more terms at least partially defining the sharing of Resource entities with Person entities within said system;
define at least one Policy, each policy having at least one associated Annotation;
assign an Attribute to an Annotation, said Attribute having a value,
define at least one Action for each Policy, an action being performed on a Resource; and
associate a Policy including an Annotation referring to one of a Person or a Resource to the other of selected stored Resources or Persons; and
said system being responsive to a request from a user associated with a Person entity to perform an Action on a Resource if said Person satisfies at least part of any Policies that are associated with said Resource or said Person, a Policy being satisfied at least if said Resource or said Person is associated with a Policy having an Annotation and the other of said Person or Resource entity has an Annotation corresponding to said Policy Annotation and said Policy has an Attribute Value for an Annotation and said Person or Resource has an Attribute Value for an Annotation corresponding to said Policy Annotation Attribute Value.

18. A system for annotation-based access control, said system being arranged to store a network of interconnected data entities, said entities including Person, Resource and Policy, wherein each Resource entity of said system is designated as being owned by a Person entity, said system being arranged to enable a user associated with a Person entity of said system to:
define an Annotation and to associate said Annotation with an entity stored by said system, said Annotation comprising one or more terms at least partially defining the sharing of Resource entities with Person entities within said system;
define at least one Policy, each policy having at least one associated Annotation;
define at least one Action for each Policy, an action being performed on a Resource; and
associate a Policy including an Annotation referring to one of a Person or a Resource to the other of selected stored Resources or Persons; and
said system being responsive to a request from a user associated with a Person entity to perform an Action on a Resource if said Person satisfies at least part of any Policies that are associated with said Resource or said Person, a Policy being satisfied at least if said Resource or said Person is associated with a Policy having an Annotation and the other of said Person or said Resource entity has an Annotation corresponding to said Policy Annotation.
